(19) United States
(12) Patent Application Publication
(10) Pub. No.: US 2025/0100483 A1
(43) Pub. Date: Mar. 27, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP)

(21) Appl. No.: 18/892,307

(22) Filed: Sep. 20, 2024

(30) Foreign Application Priority Data
Sep. 26, 2023 (JP) 2023-163175

(51) Int. Cl. B60R 16/027; B60J 7/02; B60R 16/02

(52) U.S. Cl. CPC B60R 16/027; B60J 7/02; B60R 16/0215

(57) ABSTRACT

A routing structure includes: a first fixed portion that is fixed to a vehicle body; a second fixed portion that is fixed to a sliding body that moves in a vehicle front-rear direction with respect to an opening of a roof; an exterior member that is formed by connecting a plurality of relatively rotatable tubular members and has a first end portion and a second end portion; an electric wire; and a biasing member that presses the exterior member toward the sliding body, in which the exterior member is configured such that an angle at which two tubular members rotate relative to each other is a predetermined angle or less, and the predetermined angle is an angle at which the exterior member forms a curved shape whose diameter is a first distance.

### CROSS-REFERENCE TO RELATED APPLICATION(S)

The present application claims priority to and incorporates by reference the entire contents of Japanese Patent Application No. 2023-163175 filed in Japan on Sep. 26, 2023.

### BACKGROUND OF THE INVENTION

### 1. Field of the Invention

The present invention relates to a routing structure.

### 2. Description of the Related Art

Hitherto, there has been a power feeding device for a sliding body. Japanese Patent Application Laid-open No. 2011-151906 discloses a power feeding device for a sliding body, the power feeding device including a wire harness routed over a vehicle body and the sliding body that is slidably provided in the vehicle body and opens and closes an opening formed in the vehicle body.

When a routing structure between a vehicle body and a sliding body includes an exterior member, it is desirable that a shape of the exterior member is stable. For example, the exterior member is held by the sliding body and the vehicle body in a state of having a curved portion curved in a sliding direction of the sliding body. In a case where a width of a space in which the exterior member is housed is small, a radius of the curved portion of the exterior member becomes small. If the shape of the curved portion is not stable, there is a possibility that bending durability of an electric wire routed inside the exterior member is affected.

### SUMMARY OF THE INVENTION

An object of the present invention is to provide a routing structure capable of stabilizing a shape of an exterior member.

In order to achieve the above mentioned object, a routing structure according to one aspect of the present invention includes a first fixed portion that is fixed to a vehicle body of a vehicle; a second fixed portion that is fixed to a sliding body that moves in a vehicle front-rear direction with respect to an opening provided in a roof of the vehicle body; an exterior member that is formed by connecting a plurality of relatively rotatable tubular members and has a first end portion held by the first fixed portion and a second end portion held by the second fixed portion; an electric wire that is inserted into the exterior member; and a biasing member that is inserted into the exterior member and presses the exterior member toward the sliding body, wherein the sliding body moves in a vehicle up-down direction in addition to the vehicle front-rear direction between a fully closed position where the opening is closed and a fully open position where the opening is opened, a distance from the first end portion to the second end portion in the vehicle up-down direction at the fully closed position is a first distance, a distance from the first end portion to the second end portion in the vehicle up-down direction at the fully open position is a second distance that is larger than the first distance, the exterior member is configured such that an angle at which two of the tubular members adjacent to each other rotate relative to each other is a predetermined angle or less, the predetermined angle is an angle at which the exterior member forms a curved shape whose diameter is the first distance, and the biasing member forms a curved shape in the exterior member when the sliding body is at the fully open position, the curved shape having a diameter that is the second distance.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a side view of an exterior member according to the embodiment;

FIG. 4 is a view of a tubular member according to the embodiment;

FIG. 5 is a view for describing a maximum angle when two tubular members rotate relative to each other;

FIG. 6 is a cross-sectional view of the routing structure according to the embodiment; and

FIG. 7 is a side view of the routing structure according to the embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

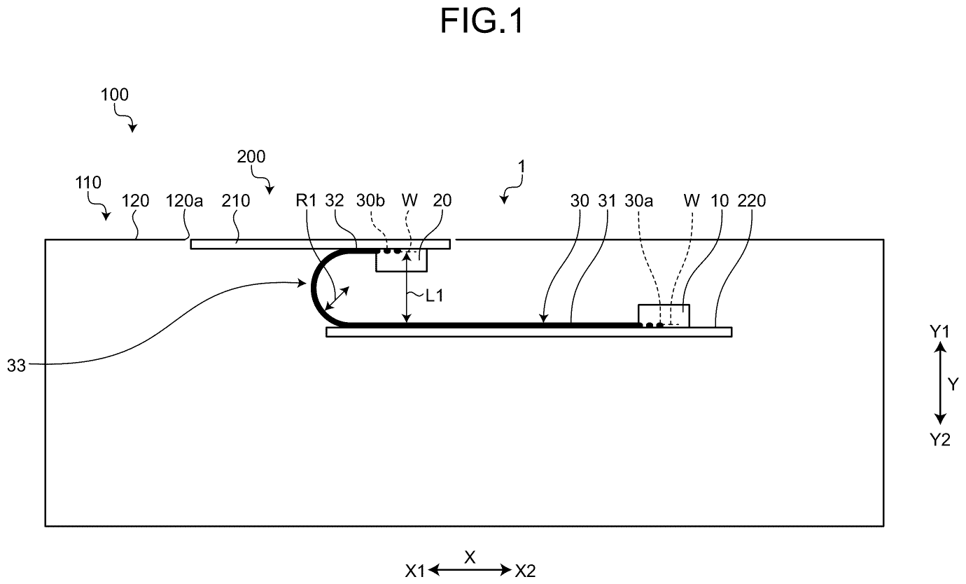

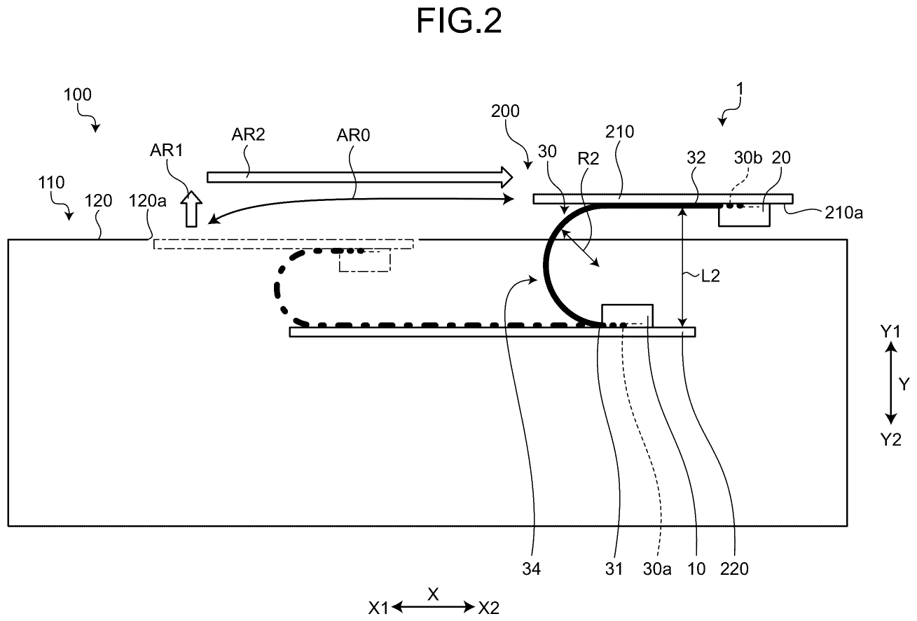

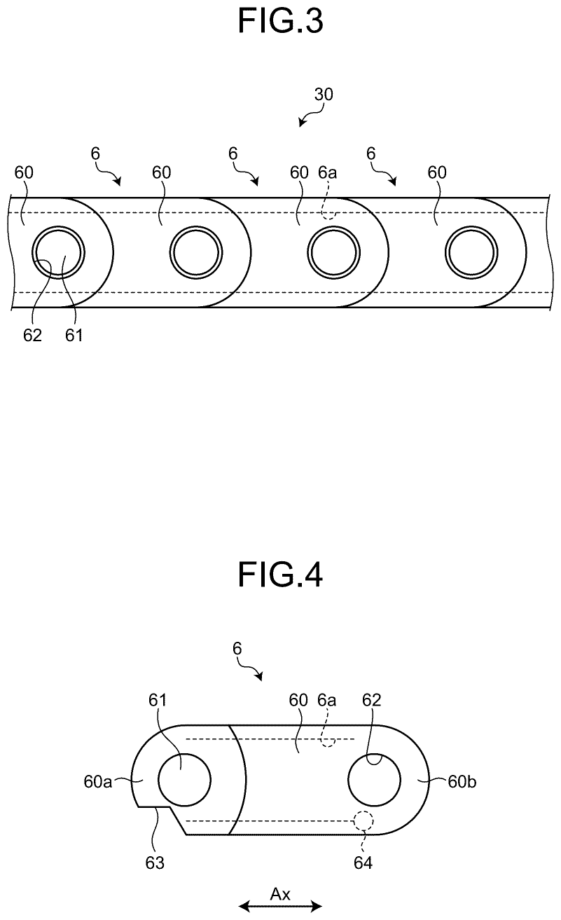

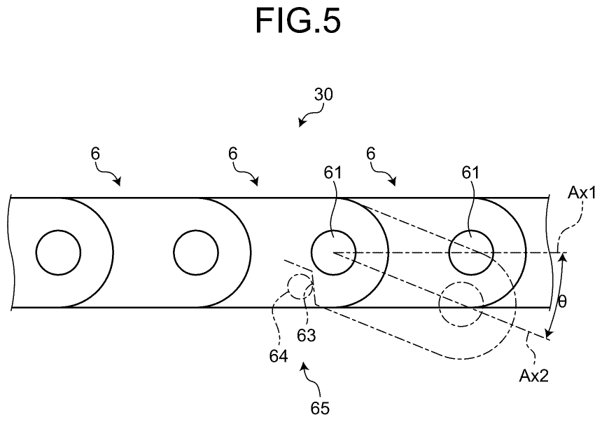

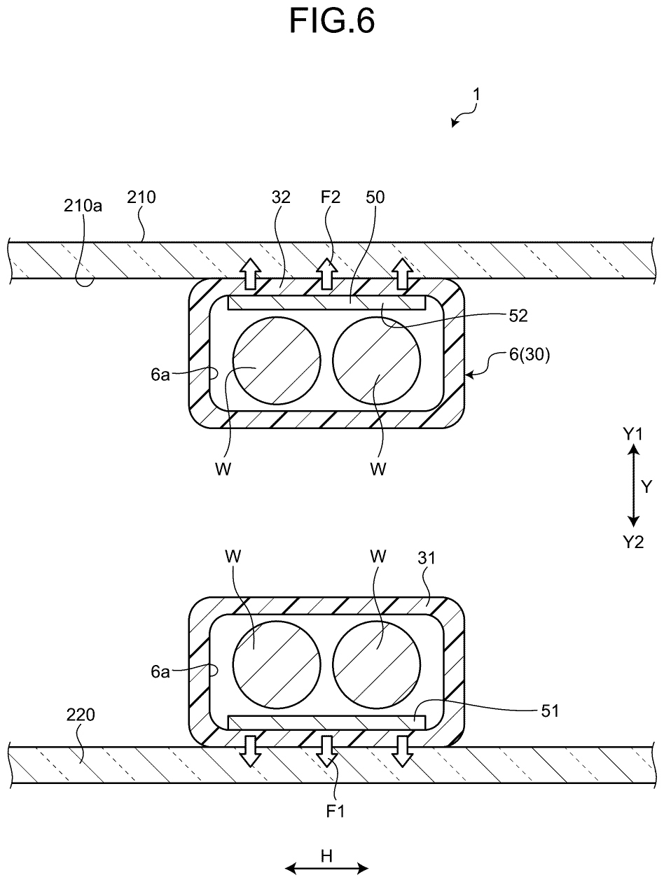

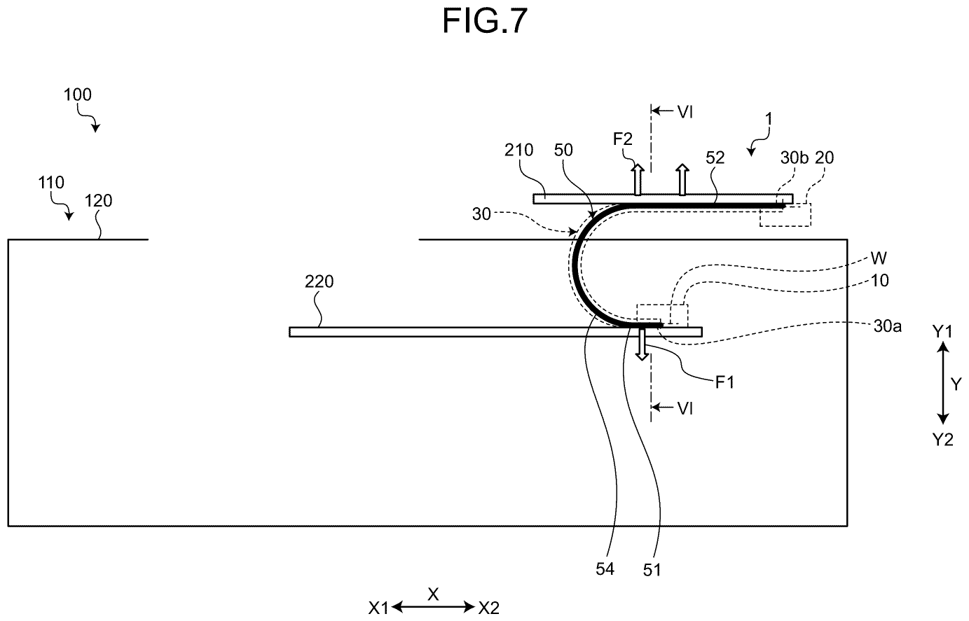

An embodiment will be described with reference to FIGS. 1 to 7. The present embodiment relates to a routing structure. FIGS. 1 and 2 are side views of the routing structure according to the embodiment, FIG. 3 is a side view of an exterior member according to the embodiment, FIG. 4 is a view of a tubular member according to the embodiment, FIG. 5 is a view for describing a maximum angle when two tubular members rotate relative to each other, FIG. 6 is a cross-sectional view of the routing structure according to the embodiment, and FIG. 7 is a side view of the routing structure according to the embodiment. FIG. 6 illustrates a cross section taken along line VI-VI of FIG. 7.

As illustrated in FIG. 1, a routing structure 1 of the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 includes a roof 120 that covers a vehicle interior. The roof 120 has an opening 120a that is opened upward.

The vehicle 100 includes a sunroof 200 that opens and closes the opening 120a. The sunroof 200 includes a sliding body 210, a rail 220, and the routing structure 1. The sliding body 210 is a member that slides in a vehicle front-rear direction X with respect to the opening 120a. The sliding body 210 of the present embodiment is a plate-shaped member that closes the opening 120a or opens the opening 120a. The sliding body 210 may be glass that can transmit light.

The sunroof 200 includes a mechanism such as a link mechanism that moves the sliding body 210 along a predetermined path, and a drive source such as a motor that operates the mechanism. The sunroof 200 moves the sliding body 210 between a fully closed position where the opening 120a is closed and a fully open position where the opening 120a is opened. FIG. 1 illustrates the sliding body 210 at the fully closed position. FIG. 2 illustrates the sliding body 210 at the fully open position.

The rail 220 is fixed to the vehicle body 110. The rail 220 extends in the vehicle front-rear direction X. The rail 220 supports the mechanism that moves the sliding body 210, and guides the mechanism in the vehicle front-rear direction X. The rail 220 further supports an exterior member 30 to form a first extending portion 31 in the exterior member 30.

The sunroof 200 of the present embodiment moves the sliding body 210 along a path AR0 illustrated in FIG. 2. The movement of the sliding body 210 along the path AR0 includes movement in the vehicle front-rear direction X and movement in a vehicle up-down direction Y. When the sliding body 210 moves from the fully closed position to the fully open position, the sliding body 210 moves toward an upper side Y1 in the vehicle up-down direction Y as indicated by an arrow AR1 in FIG. 2 and moves toward a rear side X2 in the vehicle front-rear direction X.

Conversely, when the sliding body 210 moves from the fully open position to the fully closed position, the sliding body 210 moves toward a front side X1 in the vehicle front-rear direction X and moves toward a lower side Y2 in the vehicle up-down direction Y.

The routing structure 1 of the present embodiment includes a first fixed portion 10, a second fixed portion 20, an exterior member 30, an electric wire W, and a biasing member 50. The exterior member 30 and the electric wire W form a wire harness routed between the vehicle body 110 and the sliding body 210.

The first fixed portion 10 is a member fixed to the vehicle body 110 of the vehicle 100. The first fixed portion 10 may be a protector that protects the electric wire W. The first fixed portion 10 is molded using, for example, an insulating synthetic resin. The first fixed portion 10 has a space in which the electric wire W is routed and includes a holding structure for holding the exterior member 30.

The second fixed portion 20 is a member fixed to the sliding body 210 of the sunroof 200. The second fixed portion 20 may be a protector that protects the electric wire W. The second fixed portion 20 is molded using, for example, an insulating synthetic resin. The second fixed portion 20 has a space in which the electric wire W is routed and includes a holding structure for holding the exterior member 30.

As illustrated in FIG. 3, the exterior member 30 of the present embodiment is formed by connecting a plurality of tubular members 6. The tubular member 6 is molded using, for example, an insulating synthetic resin. Adjacent tubular members 6 are connected so as to be rotatable relative to each other. A passage 6a into which the electric wire W and the biasing member 50 can be inserted is provided inside the tubular member 6.

As illustrated in FIG. 4, the tubular member 6 includes a main body 60, a shaft portion 61, a through-hole 62, a notch 63, and a contact portion 64. The main body 60 of the present embodiment has a rectangular tube shape. The passage 6a penetrating in an axial direction Ax is provided in the main body 60. The shaft portion 61 is arranged at one end of the main body 60 in the axial direction Ax. The tubular member 6 includes a pair of shaft portions 61. The pair of shaft portions 61 protrudes from the main body 60 in directions opposite to each other. The illustrated shape of the shaft portion 61 is a columnar shape.

The through-hole 62 is arranged at the other end of the main body 60 in the axial direction Ax. The tubular member 6 includes a pair of through-holes 62. Two tubular members 6 are connected by inserting the shaft portion 61 of one tubular member 6 into the through-hole 62 of the other tubular member 6. The through-hole 62 penetrates through wall portions 60b facing each other with the passage 6a interposed therebetween.

The notch 63 and the contact portion 64 restrict an angle at which two tubular members 6 rotate relative to each other within a predetermined range. The notch 63 is arranged in the vicinity of the shaft portion 61 in the main body 60. More specifically, one end of the main body 60 has an arc-shaped wall portion 60a. The shaft portion 61 is arranged coaxially with the arc shape of the wall portion 60a and protrudes from the wall portion 60a. The notch 63 is formed so as to cut out a part of an edge of the wall portion 60a.

The contact portion 64 is arranged in the vicinity of the through-hole 62 in the main body 60. More specifically, the other end of the main body 60 has the arc-shaped wall portion 60b. The through-hole 62 is arranged coaxially with the arc shape of the wall portion 60b. The contact portion 64 may be a wall portion provided between two wall portions 60b, may be a column portion, or may be a protrusion. The contact portion 64 is arranged so as to be positioned in a region formed by the notch 63 in a state in which the shaft portion 61 is inserted into the through-hole 62. When the contact portion 64 comes into contact with an end surface of the notch 63 in a case where two tubular members 6 rotate relative to each other, further rotation is restricted.

FIG. 5 illustrates a maximum angle θ when two tubular members 6 rotate relative to each other. The maximum angle θ is an angle at which the contact portion 64 of one tubular member 6 comes into contact with the end surface of the notch 63 of the other tubular member 6. The two tubular members 6 are rotatable relative to each other within a range in which an angle formed by an axial direction Ax1 of one tubular member 6 and an axial direction Ax2 of the other tubular member 6 does not exceed the maximum angle θ.

The exterior member 30 has a first end portion 30a held by the first fixed portion 10 and a second end portion 30b held by the second fixed portion 20. The first fixed portion 10 holds the first end portion 30a such that the exterior member 30 extends from the first fixed portion 10 along the rail 220 in the vehicle front-rear direction X. The first fixed portion 10 of the present embodiment holds the first end portion 30a such that the exterior member 30 extends from the first fixed portion 10 toward the front side X1.

The second fixed portion 20 holds the second end portion 30b such that the exterior member 30 extends from the second fixed portion 20 along the sliding body 210 in the vehicle front-rear direction X. The second fixed portion 20 of the present embodiment holds the second end portion 30b such that the exterior member 30 extends from the second fixed portion 20 toward the front side X1.

As illustrated in FIG. 4, the electric wire W and the biasing member 50 are inserted into the exterior member 30. The electric wire W is, for example, a sheathed electric wire including a stranded wire and a sheath. The electric wire W may be a flat routing member, a printed circuit body, or another circuit body. The electric wire W led out from the first end portion 30a is connected to a power supply or a control device arranged in the vehicle body 110. The electric wire W led out from the second end portion 30b is connected to a load arranged on the sliding body 210. The load arranged on the sliding body 210 may be, for example, a lighting device, a light control film arranged on the glass of the sliding body 210, or another electric load.

As illustrated in FIGS. 1 and 2, in the routing structure 1 of the present embodiment, curved portions 33 and 34 curved in the vehicle front-rear direction X are formed between the first end portion 30a and the second end portion 30b of the exterior member 30. The curved portion 33 illustrated in FIG. 1 is a curved portion formed in the exterior member 30 in a state in which the sliding body 210 is at the fully closed position. The curved portion 33 has a radius R1. The curved portion 34 illustrated in FIG. 2 is a curved portion formed in the exterior member 30 in a state in which the sliding body 210 is at the fully open position. The curved portion 34 has a radius R2. The electric wire W in which the curved portions 33 and 34 are formed has a U shape or a J shape.

As illustrated in FIG. 1, when the sliding body 210 is at the fully closed position, a distance between the second end portion 30b and the first end portion 30a in the vehicle up-down direction Y is a first distance L1. The radius R1 of the curved portion 33 is half the first distance L1.

As illustrated in FIG. 2, when the sliding body 210 is at the fully open position, a distance between the second end portion 30b and the first end portion 30a in the vehicle up-down direction Y is a second distance L2. The radius R2 of the curved portion 34 is half the second distance L2.

The second end portion 30b of the exterior member 30 moves together with the sliding body 210. At this time, the exterior member 30 follows movement of the second fixed portion 20 while gradually changing a position where the curved shape is formed.

As illustrated in FIGS. 6 and 7, the electric wire W and the biasing member 50 are inserted into the passage 6a of the tubular member 6. The illustrated shape of the biasing member 50 is a flat plate shape. A cross-sectional shape of the biasing member 50 in a direction orthogonal to an axial direction of the biasing member 50 is rectangular. The biasing member 50 extends from one end to the other end in a width direction H in an internal space of the exterior member 30. The biasing member 50 faces each of the plurality of electric wires W in the vehicle up-down direction Y. In other words, the biasing member 50 has a width capable of supporting the plurality of electric wires W.

As illustrated in FIG. 7, the exterior member 30, the electric wire W, and the biasing member 50 are routed in a state of being curved in a U shape or a J shape. That is, the biasing member 50 extends from the first fixed portion 10 to the second fixed portion 20 in a state of having a curved portion 54 curved in the vehicle front-rear direction X.

The biasing member 50 bent so as to have the curved portion 54 applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the sliding body 210. The pressing forces F1 and F2 are restoring forces generated in the bent biasing member 50.

The pressing force F1 forms the first extending portion 31 in the exterior member 30. The pressing force F2 forms a second extending portion 32 in the exterior member 30. The second extending portion 32 is a portion extending along a vehicle interior side surface 210a of the sliding body 210. The vehicle interior side surface 210a is a surface facing the lower side Y2. In a case where the vehicle interior side surface 210a is a flat surface, the second extending portion 32 is formed linearly. In a case where the vehicle interior side surface 210a has a curved shape, the second extending portion 32 has a curved shape along the vehicle interior side surface 210a.

In the routing structure 1 of the present embodiment, the exterior member 30 forms the curved portion 33 at the fully closed position, and the biasing member 50 forms the curved portion 34 at the fully open position as described below.

First, a configuration of forming the curved portion 33 at the fully closed position illustrated in FIG. 1 will be described. In the exterior member 30 of the present embodiment, the maximum angle θ between the tubular members 6 is set to a predetermined angle θ1 such that the tubular members 6 connected to each other form the curved portion 33. Two adjacent tubular members 6 rotate relative to each other within a range of the predetermined angle θ1 or less. The predetermined angle θ1 is determined such that the curved portion 33 illustrated in FIG. 1 is formed by relative rotation of a plurality of continuous tubular members 6 at the predetermined angle θ1.

The radius R1 of the curved portion 33 at the fully closed position is a minimum radius formed by the exterior member 30 within a range allowed by a restriction structure 65 formed by the contact portion 64 and the notch 63. That is, in the curved portion 33 having the radius R1, the two adjacent tubular members 6 bring the contact portion 64 into contact with the notch 63. As described above, the exterior member 30 of the present embodiment forms a curved shape whose diameter is the first distance L1 in a state in which relative rotation of the tubular members 6 is locked by the restriction structure 65. Therefore, when the sliding body 210 is at the fully closed position, each tubular member 6 of the exterior member 30 forms the curved portion 33. At this time, the biasing member 50 is elastically deformed into a shape corresponding to the shape of the exterior member 30.

A configuration of forming the curved portion 34 at the fully open position illustrated in FIG. 2 will be described. In a fully opened state illustrated in FIG. 2, a distance between the first end portion 30a and the second end portion 30b in the vehicle up-down direction Y is the second distance L2. The second distance L2 is larger than the first distance L1 in a fully closed state. In this case, the biasing member 50 forms the curved portion 34 having the radius R2 in the exterior member 30. As illustrated in FIG. 7, the biasing member 50 of the present embodiment has rigidity that can form the arc-shaped curved portion 54 in the fully opened state. The biasing member 50 in the fully opened state includes an extending portion 52 extending along the sliding body 210 on a side closer to the second end portion 30b than the curved portion 54. That is, the biasing member 50 applies the pressing force F2 to the exterior member 30 by the extending portion 52 positioned closer to the second end portion 30b than the curved portion 54. With such a configuration, as illustrated in FIG. 2, the second extending portion 32 that extends along the sliding body 210 is formed on the exterior member 30.

The biasing member 50 presses the exterior member 30 against the sliding body 210 with the pressing force F2 to suppress separation of the exterior member 30 from the sliding body 210. Therefore, the biasing member 50 can suppress occurrence of abnormal noise caused by vibration of the exterior member 30. Further, when the sliding body 210 moves, the biasing member 50 can set a radius of the curved shape of the exterior member 30 to a maximum radius corresponding to a position of the sliding body 210. In other words, the biasing member 50 can maximize a bending radius of the electric wire W when the exterior member 30 slides with respect to the sliding body 210 and the rail 220.

Further, the biasing member 50 presses the exterior member 30 against the sliding body 210 with the pressing force F2 when the sliding body 210 is fully closed. The pressing force F2 suppresses separation of the exterior member 30 from the sliding body 210. Therefore, the biasing member 50 can suppress occurrence of abnormal noise caused by vibration of the exterior member 30.

As described above, the routing structure 1 of the present embodiment includes the first fixed portion 10, the second fixed portion 20, the exterior member 30, the electric wire W, and the biasing member 50. The first fixed portion 10 is fixed to the vehicle body 110 of the vehicle 100. The second fixed portion 20 is fixed to the sliding body 210. The sliding body 210 moves in the vehicle front-rear direction X with respect to the opening 120a provided in the roof 120 of the vehicle body 110. The exterior member 30 is formed by connecting the plurality of relatively rotatable tubular members 6. The exterior member 30 has a first end portion 30a held by the first fixed portion 10 and a second end portion 30b held by the second fixed portion 20. The electric wire W and the biasing member 50 are inserted into the exterior member 30. The biasing member 50 presses the exterior member 30 toward the sliding body 210.

The sliding body 210 moves in the vehicle up-down direction Y in addition to the vehicle front-rear direction X between the fully closed position where the opening 120a is closed and the fully open position where the opening 120a is opened. The distance between the second end portion 30b and the first end portion 30a in the vehicle up-down direction Y at the fully closed position is the first distance L1. The distance between the second end portion 30b and the first end portion 30a in the vehicle up-down direction Y at the fully open position is the second distance L2 larger than the first distance L1.

The exterior member 30 is configured such that the angle at which two adjacent tubular members 6 rotate relative to each other is the predetermined angle θ1 or less. The predetermined angle θ1 is an angle at which the exterior member 30 forms the curved shape whose diameter is the first distance L1. The biasing member 50 forms a curved shape whose diameter is the second distance L2 in the exterior member 30 when the sliding body 210 is at the fully open position.

In the routing structure 1 of the present embodiment, the tubular members 6 form the curved shape of the exterior member 30 in the fully closed state in which the distance between the first end portion 30a and the second end portion 30b in the vehicle up-down direction Y decreases. The tubular member 6 can stabilize the shape of the curved portion 33 in the fully closed state in which the bending radius of the exterior member 30 decreases. When the sunroof 200 is fully opened, the biasing member 50 forms the curved portion 34 of the exterior member 30 and stabilizes the shape of the curved portion 34. Therefore, the routing structure 1 of the present embodiment can stabilize the shape of the exterior member 30.

The biasing member 50 of the present embodiment presses the exterior member 30 toward the sliding body 210 such that the second extending portion 32 extending along the sliding body 210 is formed on the exterior member 30 when the sliding body 210 is at the fully open position. As a result, separation of the exterior member 30 from the sliding body 210 is suppressed, and the occurrence of abnormal noise caused by the vibration of the exterior member 30 is suppressed.

The contents disclosed in the above embodiment can be appropriately combined and executed.

In the routing structure according to the present embodiment, the exterior member is configured such that an angle at which two adjacent tubular members rotate relative to each other is a predetermined angle or less, and the predetermined angle is an angle at which the exterior member forms a curved shape whose diameter is a first distance. With the routing structure of the present embodiment, a stable curved shape is formed when the bending radius of the exterior member decreases. Therefore, the routing structure of the present embodiment has an effect that the shape of the exterior member can be stabilized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixed portion that is fixed to a vehicle body of a vehicle;
a second fixed portion that is fixed to a sliding body that moves in a vehicle front-rear direction with respect to an opening provided in a roof of the vehicle body;
an exterior member that is formed by connecting a plurality of relatively rotatable tubular members and has a first end portion held by the first fixed portion and a second end portion held by the second fixed portion;
an electric wire that is inserted into the exterior member; and
a biasing member that is inserted into the exterior member and presses the exterior member toward the sliding body, wherein
the sliding body moves in a vehicle up-down direction in addition to the vehicle front-rear direction between a fully closed position where the opening is closed and a fully open position where the opening is opened,
a distance from the first end portion to the second end portion in the vehicle up-down direction at the fully closed position is a first distance,
a distance from the first end portion to the second end portion in the vehicle up-down direction at the fully open position is a second distance that is larger than the first distance,
the exterior member is configured such that an angle at which two of the tubular members adjacent to each other rotate relative to each other is a predetermined angle or less,
the predetermined angle is an angle at which the exterior member forms a curved shape whose diameter is the first distance, and
the biasing member forms a curved shape in the exterior member when the sliding body is at the fully open position, the curved shape having a diameter that is the second distance.

2. The routing structure according to claim 1, wherein
the biasing member presses the exterior member toward the sliding body such that an extending portion extending along the sliding body is formed on the exterior member when the sliding body is at the fully open position.
